(19) United States
(12) Patent Application Publication
(10) Pub. No.: US 2010/0089344 A1
(43) Pub. Date: Apr. 15, 2010

(54) INTERNAL COMBUSTION ENGINE WITH CYLINDER HEAD

(75) Inventors: Christof Knollmayr, Graz (AT); Christopher David Turner, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: AVL LIST GMBH

(21) Appl. No.: 12/571,596

(22) Filed: Oct. 1, 2009

(30) Foreign Application Priority Data
Oct. 2, 2008 (AT) A 1543/2008

(51) Int. Cl. F02F 1/40; F02F 1/42

(52) U.S. Cl. 123/41.82 R; 123/193.5

(57) ABSTRACT

An internal combustion engine comprises a cylinder head with at least one ignition device and one injection device per cylinder, at least one cooling jacket arranged in the cylinder head, with at least one cooling channel being arranged per cylinder between the ignition device and the injection device. In order to improve cooling in the region of the injection nozzles of the injection device it is provided that each cooling channel opens into a collecting channel arranged in the cylinder head.

### TECHNICAL FIELD

The invention relates to an internal combustion engine, comprising a cylinder head with at least one ignition device and one injection device per cylinder, at least one cooling jacket arranged in the cylinder head, with at least one cooling channel being arranged between the ignition device and the injection device per cylinder.

### BACKGROUND OF THE INVENTION

The specifications EP 1 626 167 A2 and U.S. Pat. No. 7,188,589 B2 each disclose a direct-injection internal combustion engine, comprising an injection device and an ignition device per cylinder, with one cast cooling channel each being arranged between injection device and ignition device. Better cooling of the injection nozzle of the injection device can be achieved with this cooling channel. It cannot be excluded however that temperature peaks occur in the region of the injection nozzles in specific operating ranges.

It is the object of the invention to avoid such disadvantages and to provide an improved cooling of the injection nozzles.

This is achieved in accordance with the invention in such a way that each cooling channel opens into a collecting channel, with preferably the collecting channel being arranged in the longitudinal direction of the cylinder head.

It is especially advantageous when each cooling channel is arranged transversally relative to the collecting channel, preferably at a right angle thereto.

In order to achieve simple production, the cooling channels and collecting channel can each be formed by bores.

In an especially preferred embodiment which enables optimal cooling of the injection nozzle at low production cost, it is provided that each cooling channel intersects with the cylinder head sealing surface of the cylinder head, with preferably the cooling channel enclosing an angle of between 10° and 45°, preferably between 20° and 40°, with the cylinder head sealing surface.

In order to ensure a sufficient pressure drop towards the collecting channel, it is advantageous when the cooling jacket is flow-connected with the collecting channel only via the cooling channels.

### BRIEF DESCRIPTION OF THE DRAWINGS

The invention is now explained below in closer detail by reference to the drawings, wherein:

FIG. 1 shows an oblique view of a water jacket of an internal combustion engine in accordance with the invention;

FIG. 2 shows a cylinder head of an internal combustion engine in accordance with the invention in a sectional view along line II-II in FIGS. 3 and 4;

FIG. 3 shows the cylinder head in a section view along line in FIG. 2, and

FIG. 4 shows the cylinder head in a sectional view along line IV-IV in FIG. 2.

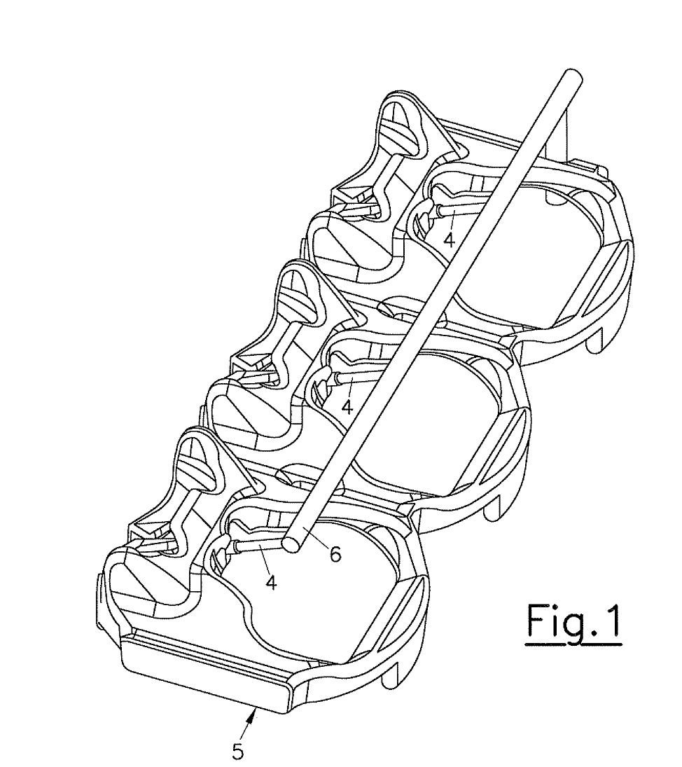

### DESCRIPTION OF THE PREFERRED EMBODIMENT

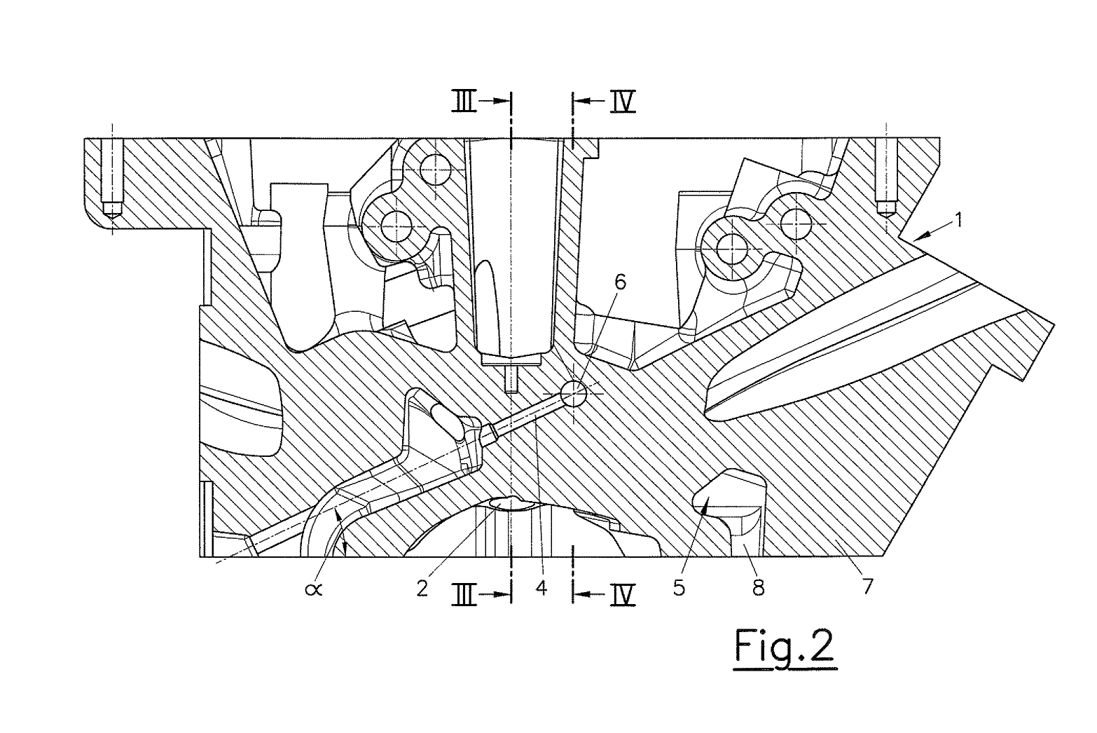

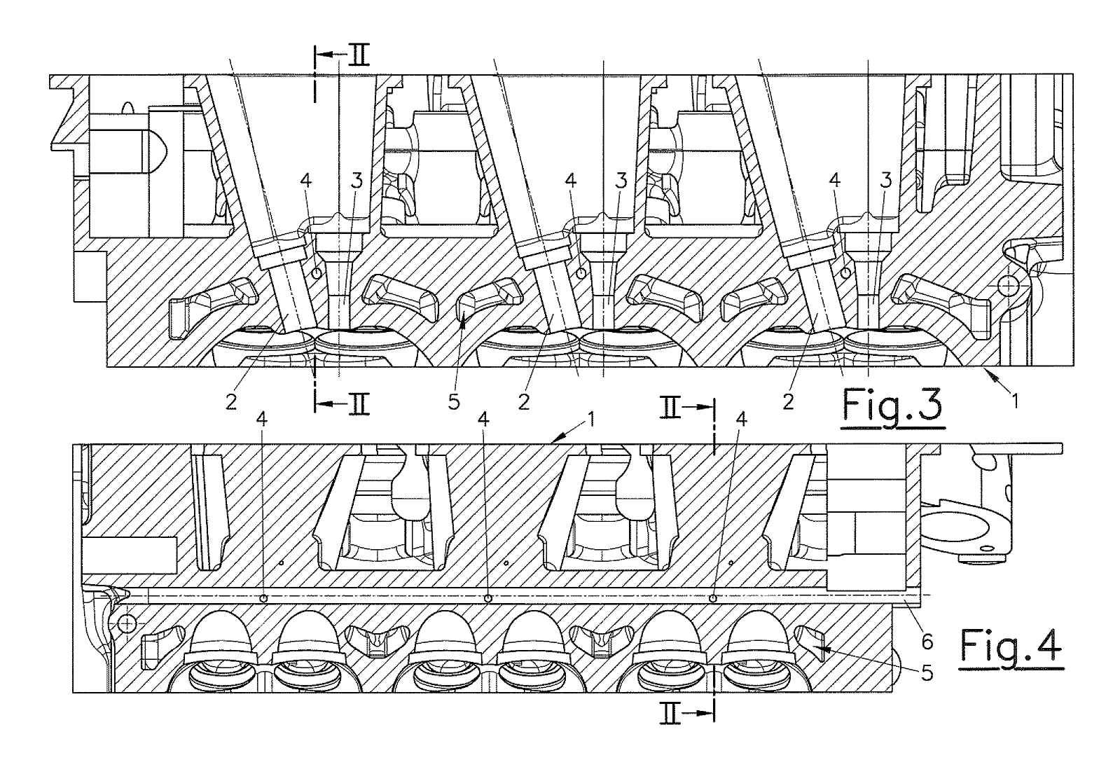

An ignition device and an injection device open into the combustion chamber per cylinder in a cylinder head 1 for several cylinders. Reference numeral 2 indicates in FIGS. 2 to 4 the shaft for an ignition device and reference numeral 3 the shaft for an injection device. A drilled cooling channel 4 is arranged between the shaft 2 for the ignition device and the shaft 3 for the injection device, which cooling channel originates from the cooling jacket 5 of the cylinder head 1. Each cooling channel 4 opens into a drilled collecting channel 6 arranged in the longitudinal direction of the cylinder head 1.

As is shown in FIG. 2, each cooling channel 4 is arranged in an inclined manner in relation to the cylinder head sealing surface 7 and encloses an angle α of approx. 20° to 30° with the same. The cooling jacket 5 of the cylinder head 1 is in flow connection with the cooling jacket of a cylinder block (not shown in closer detail) via flow transfers 8.

Dangerous temperature peaks in the region of the injection nozzle can effectively be prevented by the cooling channels 4 between the shafts 2, 3 for the ignition device and the injection device and the collecting channel 6, leading to a rapid dissipation of heat.

1-7. (canceled)

8. An internal combustion engine, comprising a cylinder head with at least one ignition device and one injection device per cylinder, at least one cooling jacket arranged in the cylinder head, with at least one cooling channel being arranged per cylinder between the ignition device and the injection device, wherein each cooling channel opens into a collecting channel arranged in the cylinder head.

9. The internal combustion engine according to claim 8, wherein the collecting channel is arranged in a longitudinal direction of the cylinder head.

10. The internal combustion engine according to claim 8, wherein each cooling channel is arranged transversally to the collecting channel.

11. The internal combustion engine according to claim 10, wherein each cooling channel is arranged at a right angle to the collecting channel.

12. The internal combustion engine according to claim 8, wherein each cooling channel is formed by a bore.

13. The internal combustion engine according to claim 8, wherein the collecting channel is formed by a bore.

14. The internal combustion engine according to claim 8, wherein each cooling channel intersects with a cylinder head sealing surface of the cylinder head.

15. The internal combustion engine according to claim 14, wherein the cooling channel is enclosing an angle of between 10° and 45° with the cylinder head sealing surface.

16. The internal combustion engine according to claim 14, wherein the cooling channel is enclosing an angle of between 20° and 40° with the cylinder head sealing surface.

17. The internal combustion engine according to claim 8, wherein the cooling jacket is flow-connected only via the cooling channels with the collecting channel.
